(19) United States
(12) Patent Application Publication
(10) Pub. No.: US 2017/0014762 A1
(43) Pub. Date: Jan. 19, 2017

(54) MERCURY REMOVAL APPARATUS, A FLUE GAS TREATMENT SYSTEM, AND A METHOD OF REMOVING MERCURY

(71) Applicant: KABUSHIKI KAISHA TOSHIBA, Minato-ku (JP)

(72) Inventors: Masaru OKAMOTO, Kanagawa (JP); Hideaki SHIMADA, Kanagawa (JP); Shinichi TERADA, Kanagawa (JP)

(73) Assignee: KABUSHIKI KAISHA TOSHIBA, Minato-ku (JP)

(21) Appl. No.: 15/199,283

(22) Filed: Jun. 30, 2016

(30) Foreign Application Priority Data
Jul. 13, 2015 (JP) 2015-139727

(51) Int. Cl. B01D 53/86

(52) U.S. Cl. CPC B01D 53/8665; B01D 53/8609; B01D 53/8625; B01D 53/869; B01D 2255/806; B01D 2257/302; B01D 2257/404; B01D 2257/602; B01D 2258/0233; B01D 2258/0291; B01D 2258/0283

(57) ABSTRACT

A mercury removal apparatus for removing the metal mercury in an flue gas containing the metal mercury and halogen, including an electro discharging device including a first electrode and a second electrode facing the first electrode, and activating the mercury by generating a streamer discharge, an oxidizing catalyst device provided at an output of the electro discharging device, to oxidize the mercury by reacting with halogen in the flue gas.

### CROSS-REFERENCE TO RELATED APPLICATION

This application is based upon and claims the benefit of priority from Japanese Patent Application No. 2015-139727, filed on Jul. 13, 2015, the entire content of which is incorporated herein by reference.

### FIELD

The present disclosures are directed to a mercury removal apparatus that removes mercury in a flue gas containing the metal mercury (HgO).

### BACKGROUND

Flue gas exhausted from a coal boiler, a waste incinerator, or a cement burning device possibly includes tiny amount of harmful substances, such as ash dust, sulfur oxides (SOx), nitrogen oxides (NOx), mercury (Hg), arsenic (As), cadmium (Cd), lead (Pb), selenium (Se), or a combination of these compounds. If these harmful substances are released into the atmosphere, these substances might be incorporated into the human body and affect human health. These substances also accumulate in a lake or sea fish and shellfish, and these fish and shellfish may negatively influence to health of a human body when consumed. Therefore, restrictions of emissions of these harmful substances are strengthening around the world.

In particular, metal mercury (HgO) is released easily from a chimney, because HgO have high vapor pressure at room temperature. Furthermore, mercury have negative influences on the human body. That is why the strict regulation of mercury is now considered, and it is necessary to remove mercury in flue gas more efficiently and exactly.

A way of removing mercury by using a Selective Catalytic Reduction apparatus (SCR) and a Flue-Gas Desulfurization apparatus (FGD) have been considered. The SCR removes NOx in flue gas by reducing NOx to N2. And the FGD removes SOx in flue gas by using an alkali absorbing solution as SOx absorbing solution.

In this way, in the flow of the flue gas, NOx is reduced and denitratined by adding ammonium (NH₃) upstream of the SCR. At the same time, a halogen compound such as hydrochloric acid (HCl) or ammonium chloride (NH₄Cl) as a mercury oxidizing agent is sprayed, and the HgO is oxidized to Hg₂+ and changed to the water-soluble mercuric chloride (HgCl₂) at the SCR. After that, the FGD removes the water-soluble HgCl₂.

As HgO has extremely low solubility into water, HgO is not absorbed into the water at the FGD. However, the HgCl₂ is easily absorbed into water, and most of HgCl₂ is removed at the FGD.

The above background method for processing in the flue gas needs to add halogen such as chlorine to change HgO to Hg₂+. However, this background method might also cause environmental problems such as increasing wastewater containing rich halogen, or increasing halogen in the flue gas from the FGD. And as the concentration of mercury in the gypsum supplied from the FGD is higher, it would be difficult to use for product.

Therefore, to remove mercury more efficiently without adding halogen and mercury compound is absorbed by scrubber on downstream of the FGD, Japanese Patent Laid-open Publication No. 2002-181757 discloses a way of removing mercury by irradiating ultraviolet rays to the exhausted gas to oxidize mercury, and removing Hg₂+.

However, because the flue gas has low consistency of mercury and the ultraviolet lamp efficiency is low, that way of oxidizing mercury by ultraviolet rays irradiating needs significant amounts of electricity. Furthermore, the transmission of ultraviolet rays decreases due to pollution of the surface of the ultraviolet lamp, which requires cleaning of the ultraviolet lamp frequently.

### SUMMARY

Accordingly, present embodiments provide a mercury removal apparatus, a flue gas treatment system, and a method of removing mercury that remove the mercury in the flue gas more efficiently and exactly.

In accordance with presently disclosed aspect, a mercury removal apparatus includes an electro discharging device including a first electrode and a second electrode facing the first electrode, which activates the mercury by generating streamer discharge, and an oxidizing catalyst device provided at an output of the electro discharging device, for oxidizing the mercury by reacting with the halogen in the flue gas.

Additional objects and advantages will be set forth in part in the description which follows, and in part will be obvious from the description, or may be learned by practice of the embodiments. The objects and advantages of the embodiments will be realized and attained by the elements and combinations particularly pointed out in the appended claims.

It is to be understood that both the foregoing general description and the following detailed description are exemplary and explanatory only and are not restrictive of the embodiments, as claimed.

### BRIEF DESCRIPTION OF THE DRAWINGS

The accompanying drawings, which are incorporated in and constitute a part of the specification, illustrate an embodiment of the embodiments and together with the description, serve to explain the principles of the embodiments.

FIG. 1 is a drawing of a flue gas treatment system according to embodiment.

FIG. 2 is an example of a configuration of a mercury oxidizing apparatus.

FIG. 3 is a longitudinal sectional view of a portion of the configuration of the mercury oxidizing apparatus.

FIG. 4 is the part of a cross-sectional view of a mercury oxidizing apparatus.

FIG. 5 is a view seen from along the direction A-A of FIG. 2

FIG. 6 is outline drawing of oxidizing apparatus for coal-fire power plant.

### DESCRIPTION OF THE EMBODIMENTS

Reference will now be made in detail to the present embodiment, an example of which is illustrated in the accompanying drawings. Wherever possible, the same reference numbers will be used throughout the drawings to refer to the same or like parts.

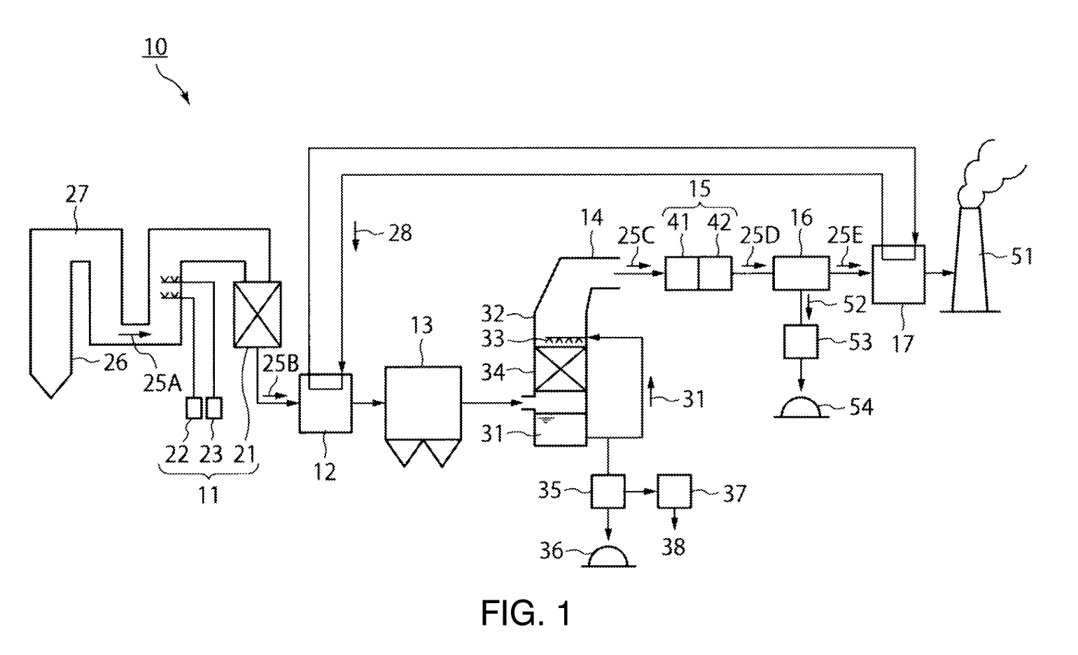

FIG. 1 shows a flue gas treatment system according to an embodiment. As shown FIG. 1, the flue gas treatment system 10 includes a Selective Catalytic Reduction apparatus (SCR) 11, a first heat exchanger (heat recovery side) 12, a dust collector 13, a Flue-Gas Desulfurization apparatus (FGD) 14, a mercury oxidizing apparatus 15, a scrubber 16, and a second heat exchanger (re-heat side) 17.

Gas exhausted from a boiler 26 is flue gas 25A, gas exhausted from the SCR 11 is flue gas 25B, gas exhausted from the FGD 14 is flue gas 25C, gas exhausted from the mercury oxidizing apparatus 15 is flue gas 25D, and gas exhausted from the scrubber 16 is flue gas 25E.

The SCR 11 includes a catalyst layer 21 and a reduction agent supplying device 22. The reduction agent supplying device 22 supplies a reduction agent such as NH₃. The reduction agent supplying device 22 is provided upstream of the catalyst layer 21. At the catalyst layer 21, the reduction agent is used for NOx reduction and denitration. The SCR 11 is heated such as above 300 Celsius degree to keep activation of the catalyst.

While the flue gas 25A exhausted from the boiler 26 is flowing at flue gas duct 27, the reduction agent is supplied from the reduction agent supplying device 22, On the SCR 11, NOx in the flue gas 25A is reduced to N₂ by as below formula (1).

4NO+4NH₃+O₂→4N₂+6H₂O (1)

A part of HgO is oxidized at the catalyst layer 21 and converted to HgCl₂ because generally, the flue gas 25A includes chlorine higher concentration than mercury (such as several thousands to several tens of thousands times more than the concentration of mercury).

The shape of the reduction catalyst layer 21 is, for example, a porous body having communicating hole cross section of which is such as honeycomb or quadrilateral geometry, fiber assembly composed by meshed geometry, body filled with particle catalyst.

The reduction catalyst could be the composition that at least one active metal selected from V, W, Mo is added to the oxidation composite of TiO₂ and SiO₂ as a carrier.

NOx in the flue gas 25A is reduced to N₂. The gas processed by the SCR 11 is supplied to the heat exchanger (heat recovery side) 12 as the flue gas 25B.

After denitration process of the flue gas 25B, the flue gas 25B is cooled by heat medium 28. After that, the dust collector 13 removes the dust in the flue gas 25B.

The dust collector 13 could be an electrostatic precipitator (ESP) or fabric filter (FF). After the dust collection process, the flue gas 25B is supplied to the FGD 14.

The FGD 14 removes SOx and HgCl₂ in the flue gas 25B. The flue gas 25B is supplied from the bottom side wall portion of apparatus body 32 of the FGD 14. An alkali absorbing solution 31 is supplied into the apparatus body 32 by a nozzle 33.

At a packed layer 34 of the apparatus body 32, the flue gas 25B flowing up from the bottom and the alkali absorbing solution 31 flowing down from the nozzle 33 are gas-liquid-contacted with each other. By this process, SOx in the flue gas 25B is absorbed in the alkali absorbing solution 31. At this point, because HgCl₂ has water solubility, HgCl₂ is absorbed in the solution 31 as well as SOx. The flue gas 25B cleaned by the solution 31 is exhausted from the top of the apparatus body 32, and supplied to the mercury oxidizing apparatus 15 as the flue gas 25C.

Here, the solution 31 could be an alkaline aqueous solution which is capable of absorbing HgCl₂ and SOx in the flue gas 25B, such as limestone gypsum slurry, calcium carbonate, calcium oxide, calcium hydroxide, sodium carbonate, an aqueous solution.

For example, the lime slurry CaCO₃ is formed by dissolving the limestone powder in water. As almost all of SOx in the flue gas 25B is SO₂, lime slurry CaCO₃ absorbing SO₂ is converted to CaSO₃.

When the limestone gypsum slurry is used as the alkaline absorbing solution 31, SO₂ in the flue gas 25B reacts with the slurry (CaCO₃) according to the following formula (3) in the apparatus body 32.

CaCO₃+SO₂+0.5H₂O→CaSO₃.0.5H₂O+CO₂ (3)

Moreover, the limestone gypsum slurry which absorbed SO₂ is mixed with water, and supplied to the apparatus body 32. After that, a mercury oxidation agent (oxidized by air) is supplied to the apparatus body 32.

In this case, limestone gypsum slurry flowing down in the apparatus body 32 reacts with water and air according to the following formula (4).

CaSO₃.0.5H₂O+0.5O₂+1.5H₂O→CaSO₄.2H₂O (4)

In this way, SOx in the flue gas 25B is captured in the FGD 14 in the form of gypsum CaSO₄.2H₂O.

The alkali absorbing solution 31 stored in the bottom of the apparatus body 32 is withdrawn from the bottom and supplied to the dewatering device 35 such as a delivered belt filter, a centrifuge, a dehydrator. After a dewatering process, the solid portion is mainly gypsum 36. As a concentration of mercury in the gypsum is not higher, the gypsum could be used for a product.

Though almost liquid portion after dewatering process could be returned to the FGD 14 for reuse, a part of liquid portion is discharged to control concentration of chlorine in the FGD for preventing corrosion. The discharged liquid is sent to waste water treatment apparatus 37.

Though oxidized mercury is removed at the FGD 14, considerable HgO exists in the flue gas 25C because mercury has a low ionization tendency. Furthermore, as SO₂ works as reduction agent in the FGD 14, some of Hg₂+ is reduced to HgO. Generally, the flue gas 25C contains about ¼ amount of HgO in the flue gas 25A.

The mercury oxidizing apparatus 15 removes the mercury remaining in the flue gas 25C exhausted from the FGD 14.

Further, generally, the flue gas 25B includes chlorine at a higher concentration than mercury (such as several thousands to several tens of thousands times the concentration of mercury). Although most of chlorine is absorbed in the FGD 14, chlorine remains at a much higher concentration than HgO in the flue gas 25C.

The mercury oxidizing apparatus 15 removes the HgO in the flue gas 25C by oxidizing the mercury using chlorine remaining in the flue gas 25C as a mercury oxidizing agent.

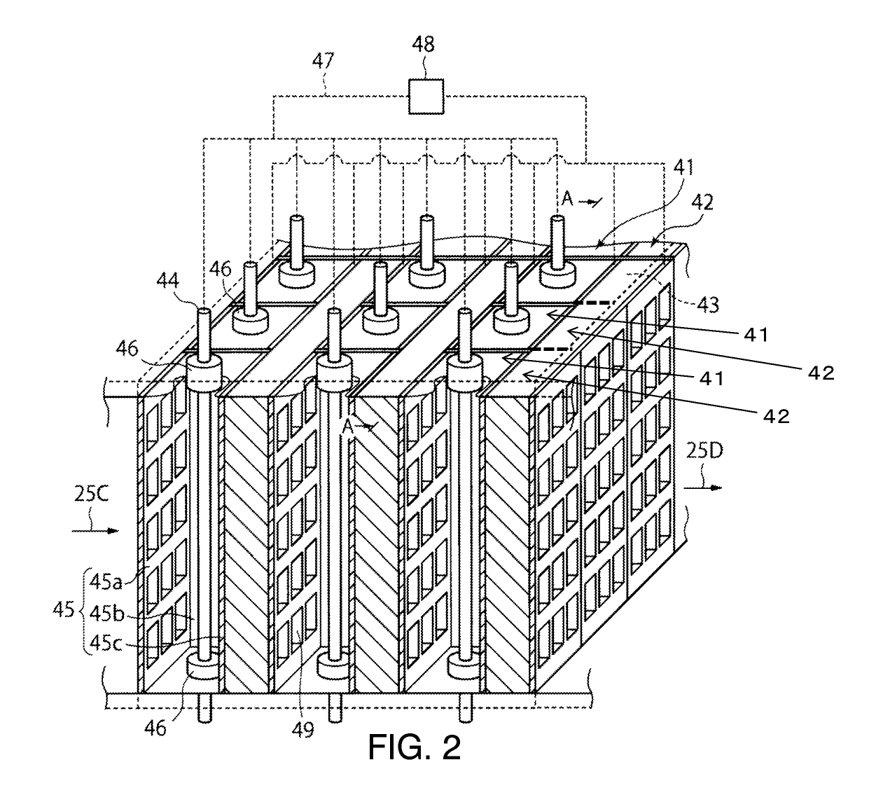

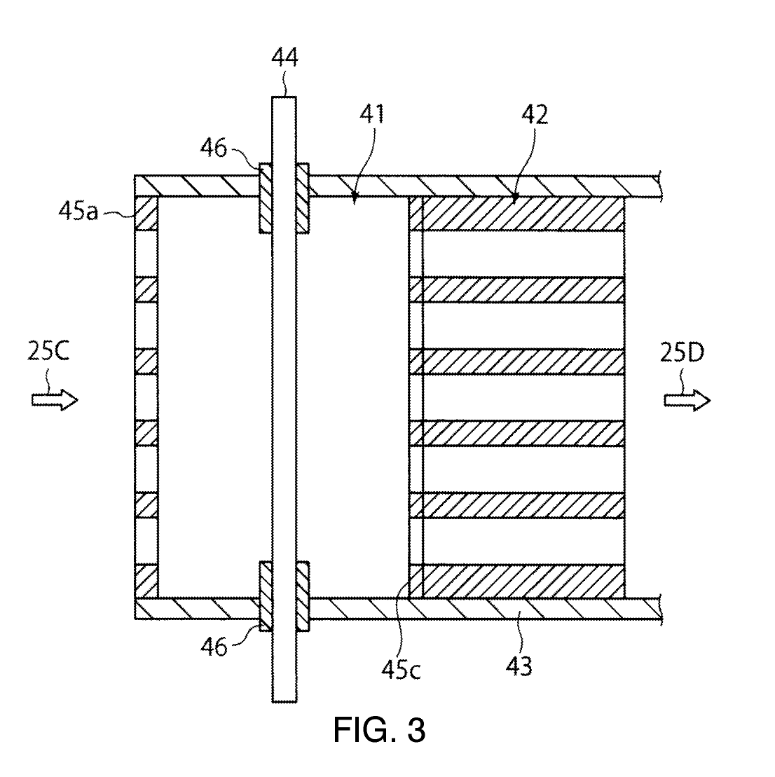

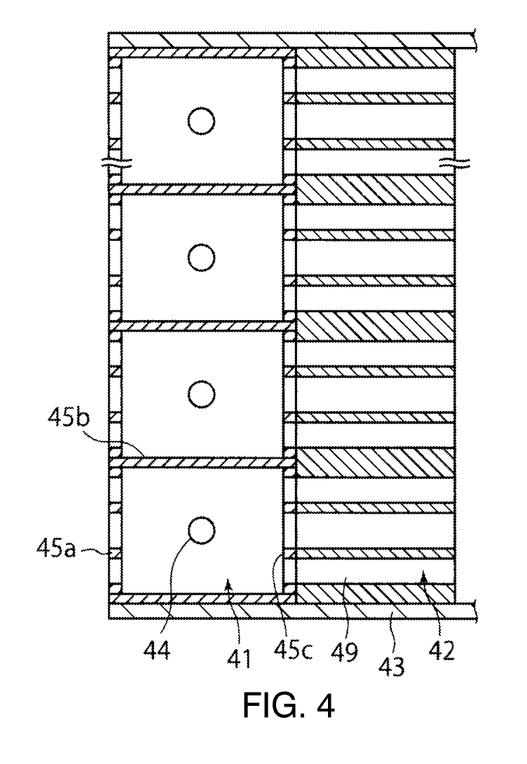

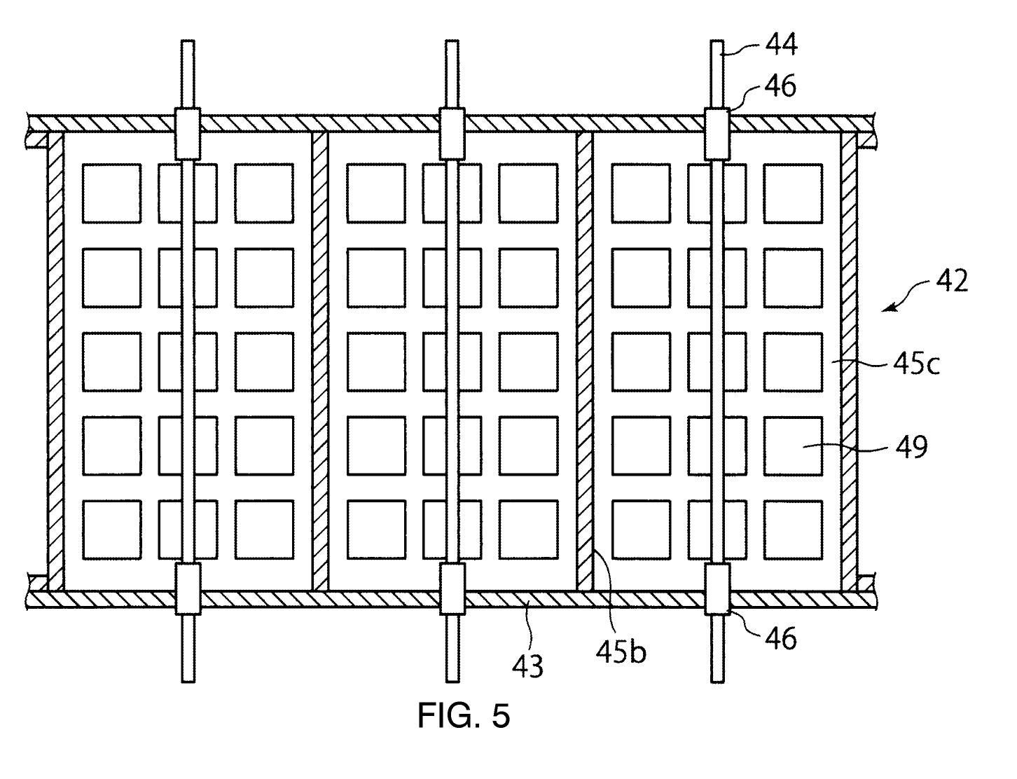

FIG. 2 is a configuration of the mercury oxidizing apparatus 15. FIG. 3 is a longitudinal sectional view of a portion of the configuration of the mercury oxidizing apparatus 15. FIG. 4 is the part of a cross-sectional view of the mercury oxidizing apparatus 15. FIG. 5 is a view seen from along the direction A-A of FIG. 2.

As shown in FIGS. 2-5, the mercury oxidizing apparatus 15 includes an electro discharge device 41, and an oxidizing catalyst device 42 inside of a body 43.

The electro discharge device 41 is provided upstream of the oxidizing catalyst device 42. Sets of the electro discharge device 41 and the oxidizing catalyst device 42 are provided in serially and in parallel.

Though, three sets of the electro discharge device 41 and oxidizing catalyst device 42 are provided serially and in parallel in FIG. 2, the number of the electro discharge devices 41 and the oxidizing catalyst device 42 could be adjusted according to the desired performance of removing mercury and the flow rate of the flue gas 25C.

An electro discharging device 41 includes a first electrode (internal electrode) 44 and a second electrode (external electrode) 45. The first electrode 44 is disposed perpendicularly to the flow of the flue gas 25C.

In FIG. 3, both ends of the first electrode 44 are fixed to the body 43 via the insulator 46. The insulator 46 is formed as a cylindrical shape, and functions as an electrode support. The first electrode 44 is fitted to the inner periphery of the insulator 46. The insulator 46 is composed of a heat resistance material such as ceramics.

The second electrode 45 is arranged facing the first electrode 44. In this embodiment, the second electrode 45 is provided around the first electrode 44 axially (in the present embodiment, the second electrode 45 has 4 surfaces).

In addition, the second electrode 45 is composed by 4 portions, the second electrode portion 45a, 45b×2 faces, 45c. The second electrode portions 45a, 45c include an opening that the flue gas 25C flows through inside. The second electrode portion 45b is provided between the electrode portion 44a and 44c provided in parallel. The second electrode portion 45b does not have the opening because the flue gas 25C does not flow through its inside.

The second electrode portion 45c is provided at the surface of the oxidation catalyst device 42, and includes an opening at the flue gas outlet side. This opening of the second electrode portion 45c communicates with a hole 49 of the oxidation catalyst device 42.

When metal, stainless steel, or conductive ceramic is used as the catalyst support of the oxidation catalyst device 42, this support functions as the second electrode portion 45c itself. In that case, the second electrode portion 45c can be omitted

In this embodiment, the second electrode 45 covers axially around the first electrode 44. However, as long as the second electrode 45 is facing the first electrode 44, the location and the number of the second electrode 45 is not limited.

The wire 47 connects the first electrode 44 and the second electrode 45. The first electrode 44 and the second electrode 45 are connected to the pulse power supply unit 48 via the wire 47. The pulse power supply unit 48 adds high voltage DC or AC to the first electrode 44. The second electrode 45 is connected to the ground of the pulsed power supply unit 48.

The flue gas 25C flows through the space between the first electrode 44 and the second electrode 45. The pulse power supply unit 48 applies pulse voltage between the first electrode 44 and second electrode 45, and streamer discharge is generated between the electrodes 44, 45.

Plasma caused by the streamer discharge becomes in a non-equilibrium state such that the electron temperature is higher than the atomic nucleus temperature. Neutral particles (nitrogen, oxygen etc.) in the flue gas 25C are excited or ionized by collision with high temperature (high-speed) electrons. An energy level of the excited electrons is estimated as 2-3 eV, equivalent to 2-3 tens of thousands Celsius degree.

The first ionization energy of nitrogen and oxygen is about 15 eV. When the electrons of nitrogen and oxygen get higher energy than the first ionization energy by high-speed electron collision, electron avalanche occurs.

Since pulse of longer width causes more frequency of collision between electrons and the neutral particles, the temperature of the neutral particles increases more. As the result, streamer discharge shifts to arc discharge.

In the streamer discharge situation, when the distance between the electrodes is about 1 cm, the resistance is about 1 k Ω. But in the arc discharge situation, the resistance is almost zero, and becomes a conductive state. And the arc discharge causes a large current flow, and in that case thermal plasma might damage the devices. Therefore, the pulse width is preferably shorter than the time for that streamer discharge to shift to arc discharge.

When the flue gas 25C flows through where the area of streamer discharge generated between the electrodes, the active species such as hydroxyl radical (OH radical), oxygen/nitrogen radicals are generated. In addition, tiny amounts of metal mercury or halogen such as chlorine in the flue gas 25C are also activated by high-speed electrons.

Here, the discharge unit 41 supplies the voltage between electrodes by the pulse power supply unit 48 when the flue gas 25C is supplied to the discharge area. And energy can be saved by adjusting the frequency according to the flow rate (the ratio of ON/OFF (duty ratio) of the pulsed power supply part 48).

The voltage pulse width is selected so that the streamer discharge is generated stably between electrodes. When the distance between the electrodes 44, 45 is too short, the discharge is not stabilized. When the distance between the electrodes 44, 45 is too long, cost of power supply voltage is too high according to adding voltage. Furthermore, a discharge field becomes non-uniform spatially, and efficiency is decreased. In this embodiment, with the conditions that the distance between the electrodes is 5 mm˜30 mm, with a peak voltage of 1 kV˜40 kV, and pulse width 500 ns or less, preferably as long as 200 ns or less, it is possible to stably maintain streamer discharge.

Here, the pulse width means interval between 50% of full voltage height. Shorter pulse width can save the energy because shorter pulse width increases electron temperature efficiently. But the rise time of an existing power supply semiconductor is limited to about 2-3 ten nanoseconds.

By adjusting the voltage and pulse width supplied from the pulse power supply unit 48 as described above, radicals are created by non-equilibrium plasma higher than the nuclear temperature in the space between the electrodes and flow to the oxidizing catalyst device 42.

Because contribution to the chemical reaction is mainly electrons by increasing the electron temperature, the catalytic reaction can occur when the neutral particles temperature is at room temperature.

Since the radicals decrease the activity by collisions with neutral particles, it is preferable that the electro discharge device 41 and the oxidizing catalyst device 42 are close to each other as much as possible. In this embodiment, the electro discharge device 41 and the oxidizing catalyst device 42 are provided in contact. However, to maintain the streamer discharge stably, as described above, appropriate spacing between the first electrode 44 and the oxidizing catalyst device 42 is necessary.

Therefore, in this embodiment, the distance between the first electrode 44 and the second electrode 45 is 5 mm or more and 30 mm or less, and is preferably in the range of 5 mm or more and 10 mm or less. Here, the distance between the first electrode 44 and the second electrode 45 means the minimum distance between the first electrode 44 and the second electrode 45.

To produce a discharge field uniformly, all of the first electrodes 44 and the second electrodes 45 are preferably substantially equal. Therefore, in this embodiment, the second electrode 45 is arranged as a planar square shape, and the first electrode 44 is provided at the center of the square.

After activating the HgO in the flue gas 25C by streamer discharge, the flue gas 25C is supplied to the oxidizing catalyst device 42.

The oxidation catalyst device 42 is provided downstream of the electro discharge device 41. The oxidation catalyst device 42 has a mercury oxidizing catalyst.

When the flue gas 25C flows into the oxidizing catalyst device 42, activated mercury in the flue gas 25C bounds with a halogen such as chlorine, bromine in the flue gas 25C, and is changed into mercuric halide. Because the flue gas 25C contains rich chlorine compared to mercury, most of the activated mercury is oxidized by chlorine in the flue gas 25C.

The time it takes for an active species to lose activity is several micro second to 2-3 milliseconds (dependent on the active species). When the flow velocity of the flue gas 25C is several meters per second, the distance through which the mercury maintains activation in the flue gas 25C in contact to the mercury oxidizing catalyst is several cm or less. Therefore, the length of the flow direction of the oxidizing catalyst device 42 is preferably less than 2-3 cm.

Generally, reacting rate on the catalyst depends on contacting time. Here, if the mercury oxidizing apparatus 15 has only one set of the electro discharge device 41 and the oxidizing catalyst device 42, a contacting time is too short to realize enough reaction, and some of the HgO may pass through without being oxidized. Because the time that active species loses activity is very short, and the distance which the flue gas 25C in contact to the mercury oxidizing catalyst with activation is very short as described above, the mercury oxidizing apparatus 15 should have multiple sets of the electro discharge device 41 and the oxidizing catalyst device 42 in series to convert enough HgO to Hg₂+.

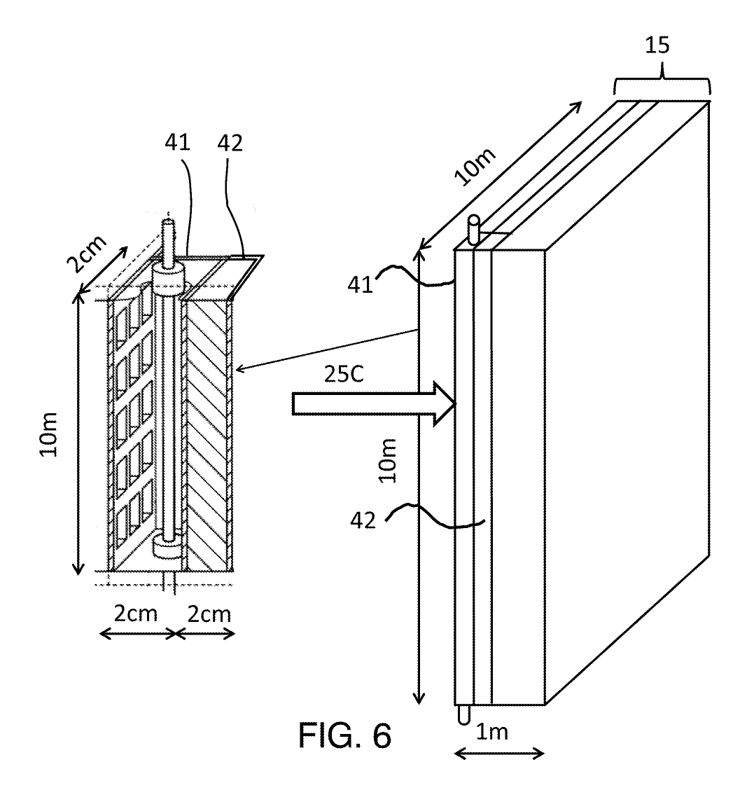

The number of parallel and series sets of the electro discharge device 41 and the oxidizing catalyst device 42 is determined by the flue gas velocity and the space velocity (the flue gas flow rate/volume of catalyst) of the oxidizing catalyst. FIG. 6 is the outline drawing of the mercury oxidizing apparatus 15 for the case of 1,000MW coal-fire thermal power plant. In that case, the flow rate is 300 million Nm3/h, space velocity of oxidizing catalyst is 30,000/h and flow velocity in the catalyst is 10 m/s. According to the above conditions, the volume of the catalyst is 100 m³, the catalyst cross section is about 10 m square, and length is about 1 m. When the electro discharge devices 41 and catalyst device 42 dimensions are 2 cm square each, the mercury oxidizing apparatus 15 can have about 500 parallel sets and 25 series sets. Power consumption of discharge for mercury oxidization is about 7MW, which is 0.7% of generating power.

Generally, the flue gas exhausted from a coal-fired power station or waste incineration facilities, since it contains a high concentration of chlorine, it is not necessary to add mercury oxidizing agent into the flue gas 25C. But, depending on the type of coal used in coal-fired power plants, there is a case that chlorine content is extremely less.

At this point, the mercury oxidizing agent is preferably chlorine or bromine among halogens, because the mercury halide needs has high solubility during removing the halogenated mercury halide which occurs from reaction with activated mercury. And, in this embodiment, the halogen gas supplied to the flue gas 25C is also called the flue gas.

The mercury oxidizing catalyst is known for example, that cordierite (2MgO.2Al2O3.5SiO2.TiO2) or titanium oxide (TiO2) for catalyst support, precious metals i.e. platinum (Pt)/palladium (Pd)/rhodium (Rh), metals of these of vanadium (V)/Molybdenum (Mo) or oxide of these metals (V2O5/MO3) for active elements and adding tungsten (W)/Cupper (Cu)/Cobalt (Co) Nickel (Ni)/zinc (Zn) or these compound on the support.

The flue gas is supplied to the scrubber 16 after HgO is oxidized to mercuric halide at the mercury oxidizing catalyst device 42. The scrubber 16 removes the mercuric halide. The scrubber 16 could be a gas-liquid contact apparatus such as a tower liquid flowing tower, spray tower, packed tower, aeration tank. Since the scrubber 16 removes the water-soluble mercury halide, mercury is highly removed from the flue gas 25D exhausted from the scrubber 16.

The absorbing solution of the scrubber 16 is a mercury oxidation agent solution, or a heavy metals collecting solution. The mercury oxidation agent solution could be a mixed solution of potassium permanganate and sulfuric acid, a mixed solution of ammonium persulfate and sulfuric acid, a mercury oxidation agent (NaClO, HClO, hydrogen peroxide), or a mercury fixing agent (chelating agents, hydrogen sulfide to make low solubility salt). The heavy metal absorption liquid could be alkali, metal ion scavenger, chelating agent.

After the mercury chloride in the exhaust 25D is removed by the scrubber 16, the exhaust 25D is supplied to the reheating heat exchanger 17 as the flue gas 25E. In the heat exchanger (reheating side) 17, the flue gas 25E is heated by heat medium 28 to prevent white smoke, and exhausted from the chimney 51 to the atmosphere.

The absorption solution containing mercury halide produced at the scrubber 16 is discharged as waste liquid 52, so that the concentration of the halogenated mercury is kept at certain amount. The waste slurry 52 is filtered to separate solid and liquid or dried by spray dryer to solidified powder. As the solid component includes high concentrate mercury, it should be solidified to prevent leakage mercury such as cement 54 and landfilled at managed landfill, or recycled by mercury reproducing apparatus.

As described above, at the exhausted gas treatment system 10, the flue gas 25 A is processed at SCR 11, the heat exchanger (heat exchange side) 12, the dust collector13, FGD 14, the mercury oxidizing apparatus 15, the scrubber 16, the heat exchanger (re-heat side) 17, and exhausted from chimney 51

The mercury oxidation device 15 activates the HgO remaining in the flue gas 25C by streamer discharge, and oxidizing the activated HgO to water-soluble mercury halide. Accordingly, the scrubber 16 can remove metal mercury remaining in the flue gas 25C easily and exactly.

As a result, the chimney 51 can exhaust the gas with mercury reduced to a very low concentration. Therefore, the flue gas treatment system 10 functions effectively also for the strict emission regulations of hazardous substances in the flue gas 25A.

A more complete appreciation of the invention and many of the attendant advantages thereof will be readily obtained as the same becomes better understood by reference to the following detailed description when considered in connection with the accompanying drawings, wherein.

What is claimed is:

1. A mercury removal apparatus for removing the metal mercury in flue gas containing the metal mercury, comprising:
an electro discharging device including a first electrode and a second electrode facing the first electrode, to activate the mercury by generating streamer discharge; and
an oxidizing catalyst device provided at an output of the electro discharging device, to oxide the mercury by reacting with the halogen in the flue gas.

2. The mercury removal apparatus of claim 1, comprising:
multiple sets of the electro discharging device and the oxidizing catalyst device provided serially.

3. The mercury removal apparatus of claim 1, comprising:
multiple sets of the electro discharging device and oxidizing catalyst device provided in parallel.

4. The mercury removal apparatus of claim 1, wherein
the second electrode surrounds the first electrode, and the second electrode includes an opening through which the flue gas flows.

5. The mercury removal apparatus of claim 1, wherein
a gap between the first electrode and second electrode is from 5 mm to 30 mm.

6. The mercury removal apparatus of claim 1, wherein
the oxidizing catalyst device includes a catalytic support composed of metal or ceramic.

7. The mercury removal apparatus of claim 1, wherein
the second electrode is arranged as a planar square shape, and the first electrode is provided at the center of the square.

8. The mercury removal apparatus of claim 1, further comprising:
a pulse power supply unit adding a pulse voltage to the first electrode.

9. The mercury removal apparatus of claim 8, wherein
a peak voltage of the pulse power supply unit is from 1 kV to 40 kV.

10. The mercury removal apparatus of claim 8, wherein
a pulse width of the pulse power supply unit is 500 ns or less.

11. The mercury removal apparatus of claim 1, wherein
the mercury oxidizing agent is selected from chlorine or bromine.

12. A exhaust gas treatment system, comprising:
a selective catalytic reduction apparatus to reduce NOx by reduction agent;
a flue gas desulfurization apparatus to remove SOx;
an electro discharging devices including a first electrode and a second electrode facing the first electrode, to activate the mercury by generating a streamer discharge; and
an oxidizing catalyst devices provided downstream of the electro discharging device, to oxidize the mercury by reacting with a halogen in the flue gas, the mercury removal apparatus provided downstream of the flue gas desulfurization apparatus.

13. A method of removing mercury in flue gas containing metal mercury, comprising:
generating a streamer discharge between a first electrode and a second electrode facing the first electrode;
activating the mercury by generating streamer discharge;
oxidizing the mercury by reacting with halogen in the flue gas by oxidizing agent.
